(19) United States
(12) Patent Application Publication
(10) Pub. No.: US 2008/0031309 A1
(43) Pub. Date: Feb. 7, 2008

(54) RECEIVER AND METHOD FOR DETECTING FREQUENCY AND TIMING OFFSETS IN MULTIPLE INPUT MULTIPLE OUTPUT (MIMO) SYSTEM

(75) Inventors: Chung-Ryul CHANG, Yongin-si (KR); Jang-Hoon Yang, Sungnam-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/833,627

(22) Filed: Aug. 3, 2007

(30) Foreign Application Priority Data
Aug. 3, 2006 (KR) 2006-0073246

(51) Int. Cl. H04B 1/06; H04B 1/713

(52) U.S. Cl. 375/147

(57) ABSTRACT

Frequency and timing offsets compensation in a Multiple Input Multiple Output (MIMO) system are provided. A receiver includes one or more antennas for receiving one or more signals using the same radio resource; a channel estimator for estimating a channel using the received signals; a transmit signal candidate pre-compensator for compensating a frequency offset and a timing offset of transmit signal candidates by estimating a frequency offset and a timing offset of one or more transmit antennas; and a demodulator for demodulating the received signals using the estimated channel information and the transmit signal candidates of the compensated frequency and timing offsets. The service coverage of the cellular system can be expanded and the transmit power of the terminal can be saved by enhancing the demodulation performance by compensating for the offset influence of each transmitter.

### PRIORITY

This application claims priority under 35 U.S.C. § 119 to an application filed in the Korean Intellectual Property Office on Aug. 3, 2006, entitled “Receiver And Method For Detecting Frequency And Timing Offsets In Multiple Input Multiple Output (MIMO) System” and assigned Serial No. 2006-0073246, the contents of which are herein incorporated by reference.

### BACKGROUND OF THE INVENTION

1. Field of the Invention

The present invention relates generally to a multiple antenna system, and in particular, to an apparatus and method for compensating for frequency and timing offsets in a receiver of the multiple antenna system.

2. Description of the Related Art

The rapid growth of the wireless mobile communication market demands various multimedia services in a radio environment. Particularly, capacity and speed of data being transmitted are increasing. For the high-speed radio communications, Orthogonal Frequency Division Multiplexing (OFDM) communication systems are being researched and developed.

Furthermore, to realize a higher data rate than the OFDM scheme, researches have combined the OFDM scheme with a Multiple Input Multiple Output (MIMO) technology. A representative example of the combination of the OFDM scheme and the MIMO technology is a Collaborative Spatial Multiplexing (CSM) technology to increase the uplink data rate in the mobile Worldwide Interoperability for Microwave Access (WiMAX).

FIG. 1 is a simplified diagram of a typical CSM MIMO system.

The CSM MIMO system of FIG. 1 includes a receiver 120 having one or more antennas and two or more transmitters 100 and 110.

Transmitters 100 and 110 simultaneously transmit different transmit signals to receiver 120 using the same radio resource.

In this example, the MIMO system includes the plurality of the transmitters, which simultaneously transmit different transmit signals using the same radio resource. In another example, the MIMO system can include a single transmitter having a plurality of transmit antennas, which transmit different transmit signals using the same radio resource.

When the radio communication system adopts the OFDM scheme, the channel equalizer is simplified and the communication system becomes robust to inter-symbol interference of the radio channel. However, using the OFDM scheme, the radio communication system becomes sensitive to the effect of frequency and timing offsets.

Accordingly, for a single transmit signal, the radio communication system using the OFDM scheme can estimate and compensate for the effect of the frequency and timing offsets. However, as for a plurality of transmit signals in the combined OFDM and MIMO, it is hard to compensate for the frequency and timing offsets. In the CSM of a Partially Used Sub-Carrier (PUSC) subchannel of the mobile WiMAX as shown in FIG. 1, it is difficult to estimate the frequency and timing offsets of the transmitters because transmitters 100 and 110 transmit the different transmit signals using the same radio resource. The PUSC subchannel includes six tiles and each tile is structured as shown in FIGS. 2A and 2B.

FIGS. 2A and 2B illustrate a typical Partially Used Sub-Carrier (PUSC) tile structure.

FIG. 2A shows a basic tile structure of the PUSC and FIG. 2B shows a tile structure of the CSM supporting PUSC.

The general PUSC tile in FIG. 2A includes 4×3 tones in frequency-time axis. Pilot symbols occupy four tones in the corners of the tile, and data occupy the remaining eight tones.

In FIG. 2B, the CSM supporting PUSC tile is constituted the same as the general PUSC tile in FIG. 2A.

Transmitters of the CSM supporting PUSC tile share and use the eight data tones of the general PUSC tile. The CSM supporting PUSC tile puts pilots of the respective transmitters in four pilot tones so that the pilots of the transmitters can keep the orthogonality without overlapping each other. For instance, transmitter 1 puts a pilot signal in the pilot tones #1 and #3, and transmitter 2 puts a pilot signal in pilot tones #2 and #4. In this situation, the transmitter 1 generates pilot tones #2 and #4 as null and transmitter 2 generates pilot tones #1 and #3 as null.

To demodulate the transmit signal as shown in FIGS. 2A and 2B., the receiver employs a demodulator of Minimum Mean Squared Error (MMSE) or Maximum Likelihood (ML) scheme. The MMSE scheme features lower computational complexity than the ML scheme in a high order modulation such as 16 Quadrature Amplitude Modulation (QAM) or 64 QAM. However, the demodulation performance of the MMSE scheme is below that of the ML scheme. Therefore, the receiver strives to reduce the computations of the ML scheme and increase the computation speed so as to enhance the demodulation performance with less computation.

The ML scheme demodulates a signal by applying every candidate group transmittable from the transmitter and selecting a candidate having the smallest error based on Equation (1).

X=arg min{∥Y−ĤX_{i,j}∥²} (1)

In Equation (1), Y denotes a receive signal vector, Ĥ denotes a radio channel response matrix after compensating for the frequency and timing offsets, and X_{i,j} denotes a transmit signal candidate vector indicative of transmittable candidate i-th value of the first transmitter and transmittable candidate j-th value of the second transmitter. X represents the final demodulated signal, which is the value of the smallest error among all possible X_{i,j}. For example, when the radio communication system is constructed as shown in FIG. 1, Y indicates the column vector of N_{R}×1, Ĥ indicates the matrix of N_{R}×2, and X_{i,j} indicates the column vector of 2×1.

As discussed above, as for the single transmit signal, when using the ML scheme for the signal demodulation, the receiver demodulates the signal by compensating for the frequency and timing offsets of the transmit signal. At this time, the receiver is constructed as shown in FIG. 3.

FIG. 3 is a block diagram of a conventional receiver in the OFDM system.

The receiver of FIG. 3 includes a Cyclic Prefix (CP) eliminator 301, a Fast Fourier Transform (FFT) processor 303, a frequency and timing offset estimator 305, a frequency and timing offset compensator 307, a channel estimator and compensator 309, and a demodulator 311.

CP eliminator 301 removes a guard interval CP from a signal received from the transmitter. FFT processor 303 converts to a frequency-domain signal by processing the time-domain signal fed from CP eliminator 301.

Frequency and timing offset estimator 305 estimates the frequency offset and the timing offset of the received signal fed from FFT processor 303. For example, frequency and timing offset estimator 305 estimates the frequency and timing offsets of the received signal using a Data-Aided (DA) algorithm having sync information or Non Data-Aided (NDA) feedforward estimation structures having statistical data of the received signal.

Frequency and timing offset compensator 307 compensates for the frequency and timing offsets of the received signal using the frequency and timing offset estimate values provided from frequency and timing offset estimator 305.

Channel estimator and compensator 309 estimates a channel with the transmitter using the signal of the compensated frequency and timing offsets fed from frequency and timing offset compensator 305. Next, channel estimator and compensator 309 compensators for a channel distortion of the received signal using the estimated channel value.

Demodulator 311 demodulates the received signal using the signal fed from channel estimator and compensator 309. For instance, demodulator 311 demodulates the received signal using the ML scheme.

As above, for the single transmit signal in the radio communication system, the receiver can process the received signal and then estimate and compensate for the frequency and timing offsets of the received signal. By contrast, in the MIMO system, the transmitter having the plurality of antennas or a plurality of transmitters transmits a plurality of signals. The transmit signals have different frequency and timing offsets respectively. Accordingly, the receiver of the MIMO system receives the plurality of signals. However, the receiver cannot estimate and compensate the frequency and timing offsets of each signal after the FFT process because the signals are not separated.

Therefore, the OFDM scheme causes degradation of the demodulation performance owing to the frequency offset and the timing offset in the MIMO system.

### SUMMARY OF THE INVENTION

An aspect of the present invention is to solve at least the above problems and/or disadvantages and to provide at least the advantages below. Accordingly, an aspect of the present invention is to provide apparatus and method for compensating for a frequency offset and a timing offset in a MIMO system.

Another aspect of the present invention is to provide an apparatus and method for compensating for a frequency offset and a timing offset with respect to a plurality of signals received using the same radio resource at the same time in a MIMO system.

A further aspect of the present invention is to provide an apparatus and method for compensating for a frequency offset and a timing offset using a transmit signal candidate group with respect to a plurality of signals received using the same radio resource at the same time in a MIMO system.

The above aspects are achieved by providing a receiver in a Multiple Input Multiple Output (MIMO) system, which includes one or more antennas for receiving one or more signals using the same radio resource; a channel estimator for estimating a channel using the received signals; a transmit signal candidate pre-compensator for compensating a frequency offset and a timing offset of transmit signal candidates by estimating a frequency offset and a timing offset of one or more transmit antennas; and a demodulator for demodulating the received signals using the estimated channel information and the transmit signal candidates of the compensated frequency and timing offsets.

According to one aspect of the present invention, a method for compensating a frequency offset and a timing offset in a MIMO system includes estimating a channel using signals received on one or more receive antennas using the same radio resource; compensating for a frequency offset and a timing offset of transmit signal candidates by estimating a frequency offset and a timing offset of one or more transmit antennas; and demodulating the received signals using the estimated channel information and the transmit signal candidates of the compensated frequency and timing offsets.

### BRIEF DESCRIPTION OF THE DRAWINGS

The above and other objects, features and advantages of the present invention will become more apparent from the following detailed description when taken in conjunction with the accompanying drawings in which:

FIG. 1 is a simplified diagram of a typical CSM MIMO system;

FIGS. 2A and 2B are diagrams of a typical PUSC tile structure;

FIG. 3 is a block diagram of a conventional receiver in an OFDM system;

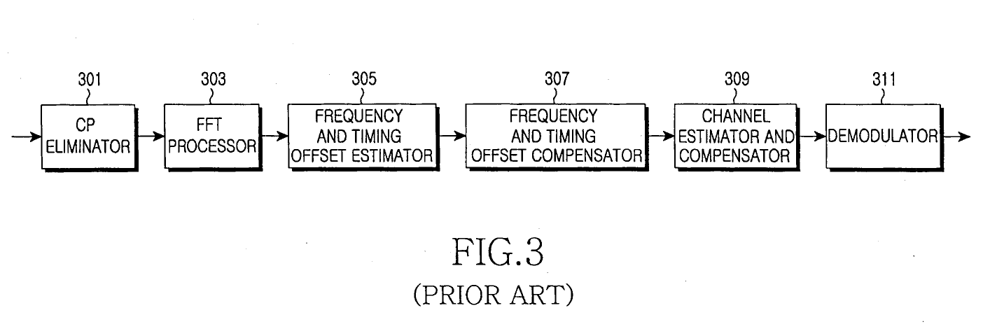

FIG. 4 is a block diagram of a receiver in a MIMO system according to the present invention;

FIG. 5 is a detailed block diagram of a transmit signal candidate pre-compensator according to the present invention; and

FIG. 6 is a flowchart of a frequency and timing offset compensating procedure in the MIMO system according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

The present invention provides a technique for compensating for frequency offset and timing offset in a receiver of a Multiple Input Multiple Output (MIMO) system; that is, a technique for compensating for frequency and timing offsets with respect to a plurality of received signals by compensating for a phase of a transmit candidate group in the receiver of the MIMO system. Since the influence of the frequency and timing offsets can be modeled as a phase rotation which linearly increases in a time-axis index and a frequency-axis index in the MIMO system, the phase of the transmit candidate group can be compensated.

The following explanation describes the receiver, which receives a plurality of signals using the same radio resource, compensates for the frequency and timing offsets of the received signals in the MIMO system. The frequency offset impedes the orthogonality by causing Inter Carrier Interference (ICI) by the frequency offset with the linear phase rotation in the same time axis. The timing offset causes the phase rotation between the subcarriers and Inter Symbol Interference (ISI) in the direction of the timing offset, and thus spoils the orthogonality. Hence, the present invention provides the technique for compensating for the frequency and timing offsets of the received signals in the receiver of the MIMO system.

Now, a radio communication system using a MIMO-Orthogonal Frequency Division Multiplexing (OFDM) scheme is explained by way of example.

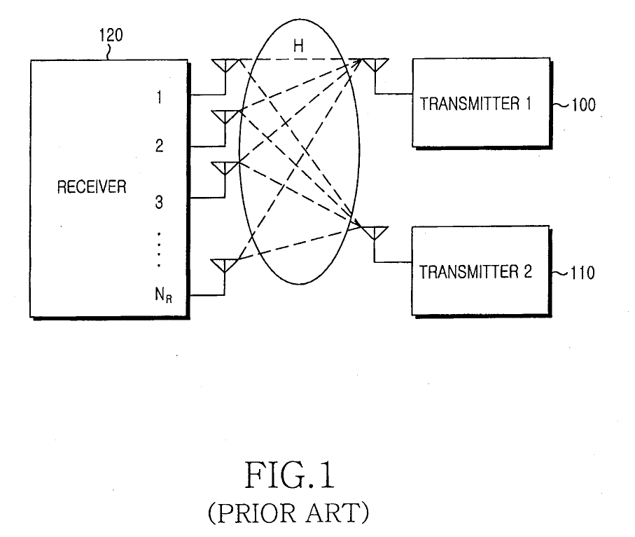

Particularly, Partially Used Sub-Carrier (PUSC) Collaborative Spatial Multiplexing (CSM) scheme is described in the MIMO-OFDM system. Accordingly, it is assumed that the MIMO-OFDM system includes two transmitters and a receiver having a plurality of receive antennas as shown in FIG. 1. Alternatively, the MIMO-OFDM system can include a transmitter having a plurality of transmit antennas and a receiver having a plurality of receive antennas.

The transmitters send different signals to the receiver using the same radio resource. The receiver receives the different signals from the transmitters through the same resource on the plurality of the receive antennas.

Hereafter, it is assumed that the receiver compensates for frequency and timing offsets in the received signals.

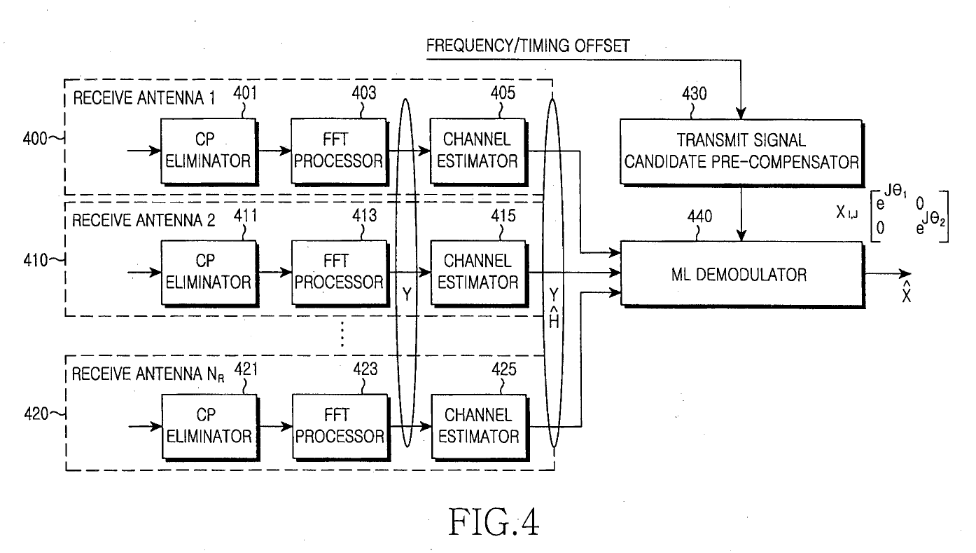

The receiver of FIG. 4 includes Cyclic Prefix (CP) eliminators 401, 411 and 421, Fast Fourier Transform (FFT) processors 403, 413 and 423, channel estimators 405, 415 and 425, a transmit signal candidate pre-compensator 430, and a Maximum Likelihood (ML) demodulator 440.

CP eliminators 401, 411 and 421 remove a guard interval CP from signals received on antennas 400, 410 and 420. FFT processors 403, 413 and 423 and convert a time-domain signal fed from CP eliminators 401, 411 and 421 to a frequency-domain signal.

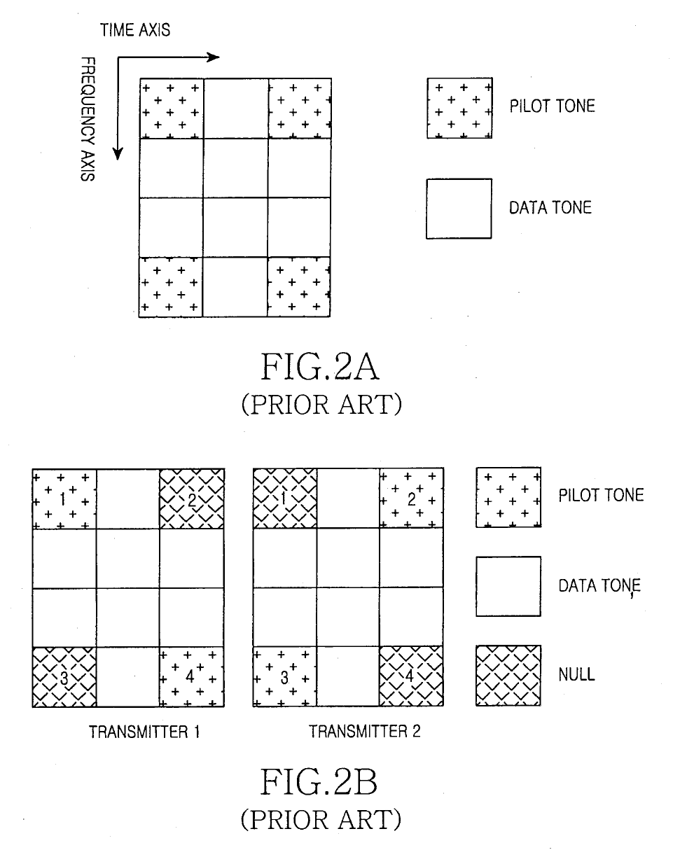

Channel estimators 405, 415 and 425 estimate a channel using pilots in the signal provided from FFT processors 403, 413 and 423. For instance, in a PUSC subchannel using the CSM, transmitters of the MIMO-OFDM system put the pilot tones to alternate with each other in the time axis and the frequency axis as shown in FIG. 2B.

Channel estimators 405, 415 and 425 estimate a channel for one tile using a mean value with respect to the pilots of the transmitters based on Equation (2).

$${H}_{1 , R , T} = \frac{1}{2} ( {Y}_{R , T , 1} + {Y}_{R , T , 3} ) \\ {H}_{2 , R , T} = \frac{1}{2} ( {Y}_{R , T , 2} + {Y}_{R , T , 4} ) \qquad ( 2 )$$

In Equation (2), H_{k,R,T} indicates an estimated channel value of T-th tile with respect to k-th transmitter and R-th antenna, and Y_{R,T,i} indicates a received signal of i-th pilot tone contained in T-th tile of R-th antenna of the transmitter. For example, when the tile is constituted as shown in FIG. 2B, transmitter 1 uses pilot tones #1 and #3 and transmitter 2 uses pilot tones #2 and #4.

The channel estimated based on Equation (2) can be expressed as a matrix represented by Equation (3).

$$H = [ \begin{matrix}{H}_{1 , 1 , T} & {H}_{2 , 1 , T} \\ {H}_{1 , 2 , T} & {H}_{2 , 2 , T} \\ ⋮ & ⋮ \\ {H}_{1 , {N}_{R} , T} & {H}_{2 , {N}_{R} , T}\end{matrix} ] \qquad ( 3 )$$

In Equation (3), H_{k,R,T} indicates an estimated channel value of T-th tile with respect to k-th transmitter and R-th antenna. For example, when two transmitters include a single antenna communicating with a receiver including N_{R}-ary receive antennas as shown in FIG. 1, H has a matrix N_{R}×2.

Transmit signal candidate pre-compensator 430 compensates frequency and timing offsets of the transmit signal candidate group by estimating frequency and timing offsets with respect to the transmitters. For instance, transmit signal candidate pre-compensator 430 estimates the frequency and timing offsets of each transmitter using the pilot in a ranging signal channel or a Channel Quality Information (CQI) channel. Since the influence of the frequency and timing offsets in the transmitters can be modeled as the phase rotation which linearly increases in the time-axis index and the frequency-axis index, transmit signal candidate pre-compensator 430 compensates the frequency and timing offsets by phase-rotating the transmit signal candidate group.

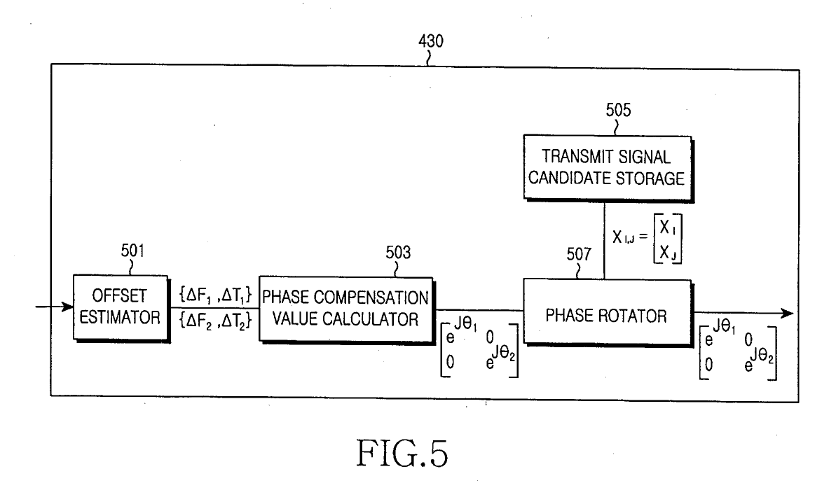

Transmit signal candidate pre-compensator 430 can be constructed as shown in FIG. 5.

ML demodulator 440 demodulates the received signals using the channel estimate values fed from channel estimators 405, 415 and 425 and the transmit signal candidate with the compensated frequency and timing offsets fed from transmit signal candidate pre-compensator 430.

Transmit signal candidate pre-compensator 430 of FIG. 5 includes an offset estimator 501, a phase compensation value calculator 503, a transmit signal candidate storage 505, and a phase rotator 507.

Offset estimator 501 estimates frequency and timing offsets Δfₖ and Δtₖ of each transmitter using the pilot in the ranging signal channel or the CQI channel.

Phase compensation value calculator 503 calculates a phase compensation value for compensating the frequency and timing offsets of the transmit signal candidate group using the estimated values of the frequency and timing offsets of the transmitters which are provided from offset estimator 501. For instance, phase compensation value calculator 503 calculates the phase compensation value for every frequency index and every time index in the tile using the estimate values of the frequency and timing offsets of the transmitters. That is, phase compensation value calculator 503 calculates the phase compensation value for compensating the frequency and timing offsets of each tone in the tile based on Equation (4).

e^{jθ}^{_{k,t,s}}=e^{jΔf}^{ₖ}^{\textcircled{x}t\textcircled{x}s}·e^{jΔf}^{ₖ}^{\textcircled{x}t\textcircled{×}s} (4)

In Equation (4), k indicates the transmitter index, t indicates the frequency-axis index of each tone in the tile, and s indicates the time-axis index of each tone in the tile. Hence, e_{jθ}^{_{k,t,s}} indicates the phase compensation value of the tone having the frequency-axis index t and the time-axis index s k-th transmitter. Δfₖ indicates a frequency offset of the k-th transmitter and Δtₖ indicates a timing offset of the k-th transmitter.

Transmit signal candidate storage 505 stores a table of the transmit signal candidates according to a modulation scheme of the transmitters. The transmit signal candidate storage 505 selects the transmit signal candidate group

$$[ \begin{matrix}{x}_{i} \\ {x}_{j}\end{matrix} ]$$

in the table and sends it to phase rotator 507.

Phase rotator 507 phase-rotates the transmit signal candidate group fed from transmit signal candidate storage 505 using the phase compensation value provided from phase compensation value calculator 503 based on Equation (5).

$${X}_{i , j} [ \begin{matrix}{e}^{{jθ}_{1}} & 0 \\ 0 & {e}^{{jθ}_{2}}\end{matrix} ] = [ \begin{matrix}{x}_{i} \\ {x}_{j}\end{matrix} ] [ \begin{matrix}{e}^{{jθ}_{1}} & 0 \\ 0 & {e}^{{jθ}_{2}}\end{matrix} ] = [ \begin{matrix}{x}_{i} {e}^{{jθ}_{1}} \\ {x}_{j} {e}^{{jθ}_{2}}\end{matrix} ] \qquad ( 5 )$$

In Equation (5), X_{i,j} indicates a transmit signal candidate vector indicative of a transmittable candidate i-th value of the first transmitter and a transmittable candidate j-th value of the second transmitter, and e^{jθ}^{ₖ} indicates a phase compensation value of k-th transmitter.

Phase rotator 507 compensates the frequency and timing offsets of the transmitters by phase-rotating the transmit signal candidate groups of the transmitters using the phase compensation value produced at phase compensation value calculator 503 based on Equation (5).

As such, the receiver compensates for the frequency offset and the timing offset of the transmit signal candidate groups of the transmitters using transmit signal candidate pre-compensator 430.

ML demodulator 440 can demodulate the received signals using the ML scheme based on Equation (6).

$$X + argmin \{ {‖ Y - {HX}_{i , j} [ \begin{matrix}{e}^{{jθ}_{1}} & 0 \\ 0 & {e}^{{jθ}_{2}}\end{matrix} ] ‖}^{2} \} \qquad ( 6 )$$

In Equation (6), X indicates a final demodulated signal which is the value having the smallest error among all possible transmit signal candidate groups X_{i,j}, Y indicates a receive signal vector, and H indicates a radio channel response matrix. X_{i,j} indicates a transmit signal candidate vector indicative of a transmittable candidate i-th value of the first transmitter and a transmittable candidate j-th value of the second transmitter, and e^{jθk} indicates a phase compensation value of the k-th transmitter.

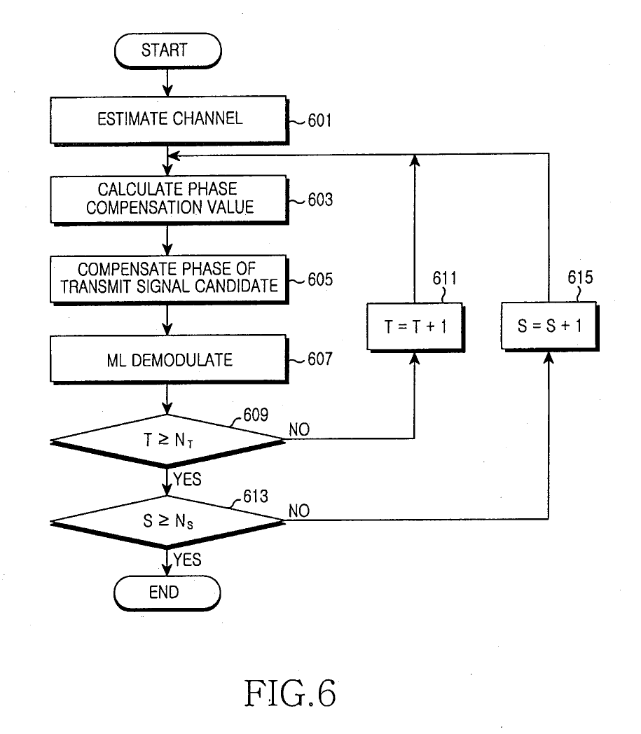

In FIG. 6, the receiver estimates the channel using the pilots of the signals received on the antennas in step 601. For instance, the receiver estimates the channel using the mean value of the pilots for each transmitter based on Equation (2).

After estimating the channel, the receiver calculates the phase compensation value for compensating the frequency and timing offsets of the frequency-axis index T and the time-axis index S in the tile in step 603. In more detail, the receiver calculates the phase compensation value for compensating the frequency and timing offsets by applying the frequency and timing offsets of each transmitter, which is estimated using the pilots in the ranging signal channel or the CQI channel, to Equation (4). Herein, T and S have ‘1’ as their initial value.

In step 605, the receiver compensates for the frequency offset and the timing offset by rotating the phase of the transmit signal candidate group of each transmitter using the calculated phase compensation value. For instance, the receiver compensates for the frequency and timing offsets by rotating the phase of the transmit signal candidate group using the phase compensation value based on Equation (5).

After compensating the frequency and timing offsets of the transmit signal candidate group, the receiver performs the ML demodulation with respect to the received signals using the channel estimate value and the transmit signal candidate group of the compensated frequency and timing offsets in step 607.

In step 609, the receiver compares T with the frequency axis magnitude N_{T} to check whether every tone of the frequency axis in the tile is ML-demodulated in step 609.

When T is smaller than N_{T} (T<N_{T}); that is, when the ML demodulation is not performed for every tone of the frequency axis, the receiver increases T by one stage (T=T+1) in step 611.

Next, the receiver calculates the phase compensation value of the tone having the frequency axis index T in step 603.

By contrast, when T is greater than or equal to N_{T} (T≧N_{T} ); that is, when the ML demodulation is performed on every tone of the frequency axis, the receiver compares S with a time axis magnitude N_{S} of the tile to check whether every tone of the time axis in the tile is ML-demodulated in step 613.

When S is smaller than N_{S} (S<N_{S}); that is, when the tones of the time axis are not ML-demodulated, the receiver increases S by one stage (S=S+1) in step 615.

Next, the receiver calculates the phase compensation value of the tone having the time axis index S in step 603.

By contrast, when S is greater than or equal to N_{S} (S≧N_{S}); that is, when the tones of the time axis are ML-demodulated, the receiver ends the process.

As set forth above, the frequency and timing offsets are compensated by rotating the phase of the transmit signal candidate group with the phase compensation value for the frequency and timing offset estimate values of each transmitter or each transmit antenna in the MIMO system. Therefore, by enhancing the demodulation performance, the service coverage of the cellular system can be expanded and the transmit power of the terminal can be saved. Additionally, the capacity can be increased by lowering the operating point of the high order modulation scheme.

While the invention has been shown and described with reference to certain preferred embodiments thereof, it will be understood by those skilled in the art that various changes in form and details may be made therein without departing from the spirit and scope of the invention as further defined by the appended claims.

What is claimed is:

1. A receiver in a communication system, comprising:
one or more antennas for receiving one or more signals using the same radio resource;
a channel estimator for estimating a channel using the received signals;
a transmit signal candidate pre-compensator for compensating a frequency offset and a timing offset of transmit signal candidates by estimating a frequency offset and a timing offset of one or more transmit antennas; and
a demodulator for demodulating the received signals using the estimated channel information and the transmit signal candidates of the compensated frequency and timing offsets.

2. The receiver of claim 1, wherein the channel estimator estimates the channel using pilots contained in the received signals.

3. The receiver of claim 1, wherein the transmit signal candidate pre-compensator comprises:
an offset estimator for estimating the frequency offset and the timing offset of the transmit antennas;
a phase compensation value calculator for calculating a phase compensation value of each tone in a tile using the estimated frequency and timing offsets;
a storage for storing the transmit signal candidates according to a modulation scheme of the transmit antennas; and
an offset compensator for compensating the frequency and timing offsets by rotating a phase of the transmit signal candidate with the calculated phase compensation value.

4. The receiver of claim 3, wherein the offset estimator estimates the frequency and timing offsets of the transmit antennas using a channel with respect to a sync acquisition signal.

5. The receiver of claim 4, wherein the sync acquisition signal is a ranging signal or Channel Quality Information (CQI).

6. The receiver of claim 3, wherein the offset compensator compensates the frequency and timing offsets of each transmit antenna by rotating a phase of a transmit signal candidate vector using a phase compensation vector of each tone which is calculated at the phase compensation value calculator.

7. The receiver of claim 3, wherein the offset compensator compensates the frequency and timing offsets by phase-rotating the transmit signal candidates based on the following equation:
$${X}_{i , j} [ \begin{matrix}{e}^{{jθ}_{1}} & 0 \\ 0 & {e}^{{jθ}_{2}}\end{matrix} ] = [ \begin{matrix}{x}_{i} \\ {x}_{j}\end{matrix} ] [ \begin{matrix}{e}^{{jθ}_{1}} & 0 \\ 0 & {e}^{{jθ}_{2}}\end{matrix} ] = [ \begin{matrix}{x}_{i} {e}^{{jθ}_{1}} \\ {x}_{j} {e}^{{jθ}_{2}}\end{matrix} ]$$
wherein X_{i,j} indicates a transmit signal candidate vector indicative of a transmittable candidate i-th value of a first transmitter and a transmittable candidate j-th value of a second transmitter, and e^{jθ}^{ₖ} indicates a phase compensation value of a k-th transmitter.

8. The receiver of claim 1, wherein the demodulator is a Maximum Likelihood (ML) demodulator.

9. The receiver of claim 8, wherein the ML demodulator demodulates the received signals based on the following equation:
$$X + argmin \{ {‖ Y - {HX}_{i , j} [ \begin{matrix}{e}^{{jθ}_{1}} & 0 \\ 0 & {e}^{{jθ}_{2}}\end{matrix} ] ‖}^{2} \}$$
wherein X indicates a final demodulated signal which is a value having the smallest error among all possible transmit signal candidate groups X_{i,j}, Y indicates a receive signal vector, H indicates a radio channel response matrix, X_{i,j} indicates the transmit signal candidate vector indicative of the transmittable candidate i-th value of the first transmitter and the transmittable candidate j-th value of the second transmitter, and e^{jθk} indicates the phase compensation value of the k-th transmitter.

10. A method for compensating a frequency offset and a timing offset in a Multiple Input Multiple Output (MIMO) system, the method comprising:
estimating a channel using signals received on one or more receive antennas using the same radio resource;
compensating for a frequency offset and a timing offset of transmit signal candidates by estimating a frequency offset and a timing offset of one or more transmit antennas; and
demodulating the received signals using the estimated channel information and the transmit signal candidates of the compensated frequency and timing offsets.

11. The method of claim 10, wherein the channel estimating step comprises:
estimating the channel using pilots contained in the received signals.

12. The method of claim 10, wherein the frequency and timing offset compensating step comprises:
estimating the frequency offset and the timing offset of the transmit antennas;
calculating a phase compensation value of each tone in a tile using the estimated frequency and timing offsets; and
compensating the frequency and timing offsets by rotating a phase of the transmit signal candidates with the calculated phase compensation value.

13. The method of claim 12, wherein the frequency and timing offsets are estimated using a channel relating to a sync acquisition signal.

14. The method of claim 13, wherein the sync acquisition signal is a ranging signal or Channel Quality Information (CQI).

15. The method of claim 12, wherein the frequency and timing offset compensating step comprises:
compensating the frequency and timing offsets of each transmit antenna by rotating a phase of a transmit signal candidate vector using the calculated phase compensation vector of each tone.

16. The method of claim 12, wherein the frequency and timing offsets are compensated by phase-rotating the transmit signal candidates based on the following equation:
$${X}_{i , j} [ \begin{matrix}{e}^{{jθ}_{1}} & 0 \\ 0 & {e}^{{jθ}_{2}}\end{matrix} ] = [ \begin{matrix}{x}_{i} \\ {x}_{j}\end{matrix} ] [ \begin{matrix}{e}^{{jθ}_{1}} & 0 \\ 0 & {e}^{{jθ}_{2}}\end{matrix} ] = [ \begin{matrix}{x}_{i} {e}^{{jθ}_{1}} \\ {x}_{j} {e}^{{jθ}_{2}}\end{matrix} ]$$
wherein X_{i,j} indicates a transmit signal candidate vector indicative of a transmittable candidate i-th value of a first transmitter and a transmittable candidate j-th value of a second transmitter, and e^{jθ}^{ₖ} indicates a phase compensation value of a k-th transmitter.

17. The method of claim 10, wherein the demodulation uses a Maximum Likelihood (ML) scheme.

18. The method of claim 17, wherein the ML demodulation demodulates the signal based on the following equation:
$$X + argmin \{ {‖ Y - {HX}_{i , j} [ \begin{matrix}{e}^{{jθ}_{1}} & 0 \\ 0 & {e}^{{jθ}_{2}}\end{matrix} ] ‖}^{2} \}$$
wherein X indicates a final demodulated signal which is a value having the smallest error among all possible transmit signal candidate groups X_{i,j}, Y indicates a receive signal vector, H indicates a radio channel response matrix, X_{i,j} indicates the transmit signal candidate vector indicative of the transmittable candidate i-th value of the first transmitter and the transmittable candidate j-th value of the second transmitter, and e^{jθ}^{ₖ} indicates the phase compensation value of the k-th transmitter.

19. An apparatus for compensating a frequency offset and a timing offset in a communication system, the apparatus comprising:
means for estimating a channel using signals received on one or more receive antennas using the same radio resource;
means for compensating for a frequency offset and a timing offset of transmit signal candidates by estimating a frequency offset and a timing offset of one or more transmit antennas; and
means for demodulating the received signals using the estimated channel information and the transmit signal candidates of the compensated frequency and timing offsets.
